(19) United States
(12) Patent Application Publication
(10) Pub. No.: US 2009/0258112 A1
(43) Pub. Date: Oct. 15, 2009

(54) USE OF PARTS OF THE BAOBAB PLANT AS ANIMAL FOOD OR AS ADDITIVE IN ANIMAL FOOD

(76) Inventor: Peter Engels, Bergisch Gladbach (DE)

Correspondence Address: KNOBBE MARTENS OLSON & BEAR LLP, 2040 MAIN STREET, FOURTEENTH FLOOR, IRVINE, CA, 92614, US

(21) Appl. No.: 12/375,930

(22) PCT Filed: Jul. 3, 2007
(86) PCT No.: PCT/EP07/05872

§ 371 Date: Feb. 17, 2009

(30) Foreign Application Priority Data
Aug. 1, 2006 (DE) 10 2006 036 168.7

(51) Int. Cl. A23K 1/14; A23L 1/302; A23K 1/16; A23K 1/175

(52) U.S. Cl. 426/72; 426/635; 426/648; 426/630; 426/425; 426/311

(57) ABSTRACT

The present invention relates to the use of plant parts of the genus Adansonia, in particular of the species Adansonia digitata (baobab or monkey bread tree) in animal food or as animal food and animal food (additives), which comprise(s) the parts of the baobab plant.

The present invention relates to the use of plant parts of the genus Adansonia, in particular of the species Adansonia digitata (baobab or monkey bread tree) in animal food or as animal food and animal food (additives) which comprise(s) the parts of the baobab plant.

The use of different constituents of the baobab plant as food for humans and for various other purposes is generally known. Thus, for example, the leaves are freshly eaten as vegetables or used in dried and ground form for the preparation of foods, such as sauces, broths, etc. The fruit pulp of the baobab plant is, on account of its vitamin content, either eaten fresh, added to cooked dishes or, on account of its pleasant taste, used as a base in the manufacture of beverages. The seeds of the baobab plant are used, for example, as binders for soups, roasted as snacks or as a substitute base for the production of coffee, or pressed as cooking oil base, etc. The ground roots of the baobab plant are used as a base for the manufacture of dyes. In medicine, the bark of the baobab plant with its astringent, diaphoretic and even antipyretic properties is used, the fruit flesh and the seeds are used, for example, in cases of fever or on inflamed wounds on account of their anti-inflammatory properties. The leaves are used to combat sweating and kidney and bladder complaints and as an anti-asthmatic agent. Cosmetic applications of various extracts from individual constituents of the baobab are likewise known.

EP 0 973 494 describes, for example, the use of an extract from leaves of a plant of the genus Adansonia, in particular of the species Adansonia digitata (monkey bread tree=baobab), for cosmetic, dermatological and pharmaceutical applications, and also a cosmetics and/or medicament product or a cosmetics or medicament composition for the skin and/or the epithelial appendages with such an extract.

Nowadays, many people keep pets or useful animals and much more emphasis is placed on balanced and healthy feeding of the animals. However, on account of various circumstances, despite the wide supply of animal food, malnutrition of the animals with regard to certain required food constituents can result, e.g. during pregnancy, during illness, in young animals during the growth phases, in injured or aging animals, etc. . . .

It was an object of the present invention to provide a high-value food or food supplement which is tasty and therefore well received by the animals and which counteracts such malnutrition.

This object is achieved by an animal food or a food supplement, comprising at least one additive from at least one constituent of a plant of the genus Adansonia, in particular of the species Adansonia digitata (baobab plant), A. grandidieri, A. za or A. gibbosa.

Whenever the term “baobab” or “baobab plant” is used below, any of the plant genera mentioned above are therefore intended.

This additive is preferably either a plant constituent in comminuted form or an extract from at least one constituent of a plant of the genus Adansonia, this extract preferably not being obtained by hot extraction. This additive can itself be used as food (supplement).

In one embodiment of the present invention, an additive from at least one constituent of the baobab plant, in which the constituents naturally occurring in the baobab plant are present without significant degeneration, is incorporated into an animal food which can comprise the customary constituents of such a composition suitable in each case for a certain type of animal. In other words, this means that such additives are produced from the plant part(s) without subjecting the substances present in the plant parts to high, e.g. thermal, stress.

In a further embodiment of the present invention, the constituents of the plant are either provided directly in fresh or dried, comminuted form and used as such as animal food, in an animal food or preferably as animal food supplement, or an aqueous extract is produced from the constituents which, during production, has only been heated to at most moderate temperatures, and this is incorporated into a composition serving as food or food supplement. Moderate temperatures are to be understood here as meaning a temperature of at most 65° C., preferably of at most 50° C., particularly preferably of at most 40° C.

The drying of the constituent/constituents can take place by one of the known types of drying, with either air drying or freeze-drying being preferred. A temperature increase during drying is possible, but the temperature should preferably not exceed the aforementioned values here either. Drying under environmental conditions in the countries of manufacture, thus e.g. Africa with daytime temperatures sometimes in the region of more than 40° C. (also significantly higher in the sun) however, likewise falls within the scope of the present invention. Provided the plant constituents are not subjected to an extraction method, the temperature is not as disadvantageous for the substances located in the plant parts as after the leaching out from the “natural environment” by an extraction method. Consequently, in the case of the direct incorporation of the plant constituents (without extraction method) into the preparations described here, the temperature applied during drying is not limiting for the invention.

By virtue of this type of work-up of the plant constituents, thus either (drying and) comminution, or with (if appropriate additional) use of a temperature-limited extraction step, the substances present in the plant constituents are treated in a particularly gentle manner. As a result the additives from constituents of the baobab plant incorporated into the food (supplements) have a largely “original” composition, i.e. a composition as also exists in the constituent(s) used in their natural environment.

Many of the substances found in the constituents of the plant are exceptionally labile toward the effect of heat—especially outside of the “protective” plant structure. Consequently, these are often largely destroyed in an extraction method during which intense heating takes place. Therefore, in an extraction according to the invention, an extract from at least one constituent of the baobab plant is produced in which the constituent(s) in an extractant are subjected to a temperature above 65° C. for a maximum of a few seconds (at most 10). Preferably, a temperature of more than 65° C. is not reached. In one embodiment of the invention, such a “cold” extract is then incorporated into animal food or a food supplement. Suitable extractants for such an extraction are, for example, water (also with the addition of various soluble substances such as, for example, salts or buffer substances), an organic solvent such as an oil, in particular one of those specified below for the formulations, without, however, being limited thereto. Any suitable extraction method can be used for the extraction, preference being given to physical extraction methods, e.g. with the help of ultrasound.

In a preferred embodiment, the plant constituents are not subject to an extraction method, but are either comminuted in the fresh or dried state (drying can also take place after the comminution), the resulting particles are, if appropriate, separated according to size and used directly as animal food (supplement) or incorporated into such a product. Comminution of the plant constituents can take place by any suitable method such as, for example, trituration, grinding, cutting, chopping or the like, without being limited thereto. After the comminution, the prepared powder or mush can be separated into size fractions by suitable measures e.g. by sieving (in particular in the case of powders), slurrying (in the case of mush), etc., so that the particles incorporated into the food formulas have, if desired, a certain size distribution. However, this is not obligatory for the invention, but instead depends on the processing parameters of the composition to be produced.

According to the present invention, constituents of a plant of the genus Adansonia, in particular of the species Adansonia digitata (monkey bread tree=baobab), A. grandidieri, A. za or A. gibbosa directly or extracts therefrom which have been processed with at most moderate heating, can be incorporated into animal food (supplements), or be used as such. Suitable constituents of the plants are, in particular, the fruit pulp, the leaves, the bark, the seeds contained in the fruit pulp, the flowers and the roots. Each of these constituents can be used individually according to the invention, or as a mixture of two or more of these constituents. In a particularly preferred embodiment of the invention, fruit pulp and/or leaves are used as at least one constituent.

The various constituents of the plants comprise mixtures of different substances which are particularly suitable for use as animal food (supplements). Thus, the leaves comprise primarily many proteins, a high calcium content and a high content of vitamins A and E, the fruit pulp is characterized by a high vitamin C and calcium content, and also by a high fraction of pectin, the seeds comprise oils with unsaturated fatty acids and have a high protein content. Since these are natural products, a specific concentration of a substance or a ratio of the substances to one another cannot be determined definitively, although reference is made to the following references: Gebauer, J. et al., Gartenbauwissenschaft (2002), 67(4), pp. 155-160; Nour, A. et. al., Trop. Sci. (1980), 22(4), pp. 383-388. Moreover, the plant constituents comprise a significant content of roughage which is beneficial to the healthy digestion of the animals.

The plant constituents or the extracts can be administered to any desired animal, being particularly suitable for supplementing the feed of animals which are malnourished in some way. Malnourishment in the present case is intended to mean in particular that there is a significant need by an animal for certain food constituents which is not completely met by the food usually administered, or that the animal would have to consume excessive amounts of the food usually administered in order to meet this need. In such cases, either the plant constituents or extracts described here can be added to the corresponding animal food directly by the manufacturer, or the plant constituents or extracts can be provided as food supplement which is then added to the food usually administered to the animal by the animal handler.

In this way, the feed for pets and useful animals, such as, for example, horses, cows, donkeys, sheep, goats, dogs, cats, pigs, hares, rabbits, guinea pigs, hamsters or birds (without being limited thereto) can be enriched, as well as that of zoo animals and exotic animals such as, for example, monkeys, zebras, antelopes, giraffes, big cats, buffalo, rodents and many more, without being limited to the specified animals.

Food supplementation of the usual food with the plant constituents or extracts described here—either through incorporation into the food by the manufacturer, or through addition of a supplement by the animal handler—is appropriate in particular for
pregnancy of the animals
sick animals or animals with weakened immunity
young animals, in particular during the growth phases
aging animals, in particular those with weakened bone material,
animals during intensive work phases (for example show/competition season in the case of horses, endurance training in the case of dogs and the like)
for increasing output of milking cows without being limited to these scenarios.

In particular, the high vitamin C, vitamin A, vitamin E, vitamin B, calcium and protein contents of the plant constituents, preferably of the fruit pulp, of the leaves and of the bark, and also the content of unsaturated fatty acids of the seeds make these constituents particularly valuable food constituents. For example, 100 g of fruit pulp of the baobab comprise 75.6% carbohydrates (some in the form of roughage such as cellulose), 2.3% proteins and a very low content of fat (0.27%), but a high content of vitamin C (ca. 300 mg/100 g of pulp), which corresponds approximately to six times the vitamin C content of a whole orange. Only as comparison: the recommended daily dose of vitamin C for a person is 75 to 90 mg per day. Moreover, the fruit pulp contains a high calcium content (approximately 300 mg per 100 g of pulp) and a high content of vitamin B2, which is required to an increased degree during growth, and of vitamin B3, which is involved in various metabolic processes.

In a preferred embodiment, moreover, the plant constituents provided according to this invention as food (supplement) can be mixed with further food constituents or food supplements advantageous for the organism before they are incorporated into the food, or are used as food supplements.

In particular, further additives can be selected from the group of mineral substances, vitamins, trace elements, sugar, malt, molasses, grain, bran, seeds (in particular of oil plants), proteins, amino acids, salts, oils, fats, fatty acids, fruits, fruit constituents or fruit extracts or mixtures thereof.

Suitable and preferred minerals and trace elements are, for example, phosphorus, iron, potassium, sodium, magnesium, iodine, fluorine, zinc, manganese, selenium, nickel, cobalt, chromium, copper, zinc, molybdenum, lithium, silicon and their biologically effective compounds and salts. Such minerals and trace elements are added to the mixture, preferably in an amount which leads, upon a daily dose of the food (supplement), on average to a dose of, for example, 0.1 mg to 0.4 mg of iron, 0.1 mg to 0.26 mg of zinc, 20 μg to 40 μg of copper, 25 μg to 70 μg of manganese, 1.3 μg to 4 μg of iodine, 25 μg to 60 μg of fluorine, 1 μg to 3.5 μg of molybdenum, 0.7 μg to 2.7 μg of chromium and 0.25 μg to 1.4 μg of selenium per kg of body weight of the animal. If necessary, the mixing ratio can be correspondingly adjusted to higher or lower doses.

Vitamins can be added to the food (supplement) according to the invention, it being possible for the plant constituents to already comprise an adequate amount of vitamin C, A, B2, B3 and E. In special-need cases, however, in particular the vitamins A (particularly for aging animals), B1 (for pregnancy), B2 (for disease states, during pregnancy), B3 (for diarrheal illnesses, allergies, circulation-increasing), B6 (during pregnancy and for young animals), D (during pregnancy and for young animals) and/or E (in particular for breeding animals) can be supplied. The requirement for vitamin C and calcium is, for example, increased during pregnancy and suckling time to up to three times the normal requirement; therefore, the administration of the plant constituents fruit pulp and leaves is suitable particularly for animals in such a condition, and also for animals which are sick and/or have weakened immunity.

For reasons of taste, and also for increasing the supply of energy, sugars, in particular glucose and/or fructose, can also be added, as can malt, molasses and/or e.g. sugar beet chips.

Oils to be used preferably are natural oils such as, for example, olive oil, sunflower oil, soy bean oil, peanut oil, rapeseed oil, wheat germ oil, grape seed oil, safflower oil, macadamia nut oil, baobab oil, avocado oil and the like.

The plant constituents or extracts used can—if appropriate in a mixture with at least one of the aforementioned further additives—be provided directly as food (supplement), or be incorporated into a food suitable and adapted for the particular animal. In the case of incorporation into a food otherwise adapted for a certain type of animal, formulation of the food is not necessary, but may be carried out. For incorporation, the plant constituents can be selected according to size, so as not to constitute any troublesome component in the finished food. The suitable size depends on the form in which the rest of the food is offered to the animal. In any case, it is advantageous if the particle size of the plant constituents chosen is not too coarse. The incorporation of an extract is also to be considered advantageous.

The particle size of the plant constituents to be incorporated can vary widely depending on the type of animal. For large animals, in particular animals the size of horses, cows, zebras, buffalo, etc., very coarse plant constituents can be used, for example, particles with a size of a few cm. Preferably, however, a particle size of not more than 5 mm is used even for these animals, especially if it is provided in the form of a food supplement to be mixed into a food. For smaller and sensitive animals, it is preferred to keep the particle sizes of the incorporated particles essentially below 1000 μm, preferably essentially below 500 μm, particularly preferably below 200 μm. “Dust”, i.e. particles below 50 μm, preferably below 20 μm, can also be incorporated into the formulations according to the invention.

When incorporating an extract, up to 50% by weight of such an extract can be incorporated into a food formula (as food or as supplement). Particularly if the extract has been produced with the help of aqueous solvents or oils, the extract can directly constitute part of the food formula. Usually, however, the extracts are incorporated into the compositions in a range from 0.01 to 20% by weight, preferably 0.05 to 10% by weight, particularly preferably 0.05 to 5% by weight.

As already described, the amount of the plant constituents to be incorporated and their particle size is, just like the amount of extracts to be incorporated, dependent on the particular type of animal under consideration.

In the case of the provision of the plant constituents —if appropriate in a mixture with at least one of the other aforementioned additives—as food supplement, this can be provided directly as a mixture of the constituents without formulation, or in the form of granules, compacts, pellets, powders, dragees, syrup, a suspension or any other suitable administration form, without the invention being limited thereby.

The food supplement is suitably provided in a form which allows the animal handler to administer an individual dose to the particular animal. This is provided in a particular manner, for example, in the case of a powder or granules, but also with dragees or pellets. The composition to be administered is preferably dosed so that 5 to 500 mg, preferably 20 to 400 mg, particularly preferably 50 to 300 mg, of the plant constituent(s) are administered to the animal per day per kg of live weight of the animal. In the case of mixing with other constituents, a correspondingly higher total amount of the food supplement which takes into consideration the additional constituents should preferably be stated.

Through the incorporation of the baobab constituents and/or of the extracts thereof, produced under gentle conditions, the active ingredients present in the plant constituents are available to the organism in a suitable manner.

The other food constituents of the particular food for the individual animals play no role for the present invention and in no way limit it. All of the foods into which the plant constituents or extracts of the present invention can be incorporated, or to which these can be added, may be customary types of food found on the market or types of food recently developed for a type of animal. In this connection dry foods are just as suitable as fresh foods, or else types of food to be mixed with liquid or similar. When using the invention as food supplement, this can be either mixed into usual animal food by the animal handler or another person feeding the animal, or it can be administered to the animal independently of the other animal food.

1. An animal food or animal food supplement, comprising at least one additive from at least one constituent of a plant of the genus Adansonia, in particular of the species Adansonia digitata (baobab plant), A. grandidieri, A. za or A. gibbosa.

2. The animal food or animal food supplement as claimed in claim 1, comprising a plant constituent in comminuted form, or an extract from a plant of the genus Adansonia.

3. The animal food or animal food supplement as claimed in claim 1, wherein the additive is at least one fresh or dried plant constituent in comminuted form, and/or an extract from at least one plant constituent, where the extract has preferably been produced entirely under temperature conditions below a maximum of 65° C.

4. The animal food or animal food supplement as claimed in claim 1, wherein, besides the additive from a constituent of the baobab plant, at least one further additive is present, selected from the group consisting of mineral substances, vitamins, trace elements, sugar, malt, molasses, grain, seeds, in particular from oil plants, proteins, amino acids, salts, oils, fats, fatty acids, fruits, fruit constituents and fruit extracts or mixtures thereof.

5. The animal food or animal food supplement as claimed in claim 1, wherein plant constituent(s) is/are selected from the group consisting of fruit pulp, leaves, bark, flowers, seeds and roots or combinations thereof, or the extract is produced from at least one of these constituents.

6. A method of manufacturing an animal food or animal food supplement comprising adding a plant constituent in comminuted form and/or of an extract from a plant of the genus Adansonia, in particular the species Adansonia digitata (baobab plant), A. grandidieri, A. za or A. gibbosa.

7. The method as claimed in claim 6, wherein the plant constituent or the extract is from at least one of the constituents selected from the group consisting of fruit pulp, leaves, bark, flowers, roots and seeds.

8. The method as claimed in claim 6, wherein the plant constituent or extract is combined with at least one further constituent selected from the group consisting of mineral substances, vitamins, trace elements, sugar, malt, molasses, grain, seeds, in particular from oil plants, proteins, amino acids, salts, oils, fats, fatty acids, fruits, fruit constituents and fruit extracts or mixtures thereof.

9. The method as claimed in claim 7, where the plant constituent is fruit pulp or leaves or a mixture thereof.
